(19) United States
(12) Patent Application Publication
(10) Pub. No.: US 2010/0238766 A1
(43) Pub. Date: Sep. 23, 2010

(54) SONAR BAFFLES AND BACKINGS

(75) Inventors: Jonathan Michael George Penny, Hampshire (GB); Michael Edward Woods, Hampshire (GB)

Correspondence Address: BUCHANAN, INGERSOLL & ROONEY PC, POST OFFICE BOX 1404, ALEXANDRIA, VA, 22313-1404, US

(73) Assignee: BAE Systems plc, London (GB)

(21) Appl. No.: 12/307,575

(22) PCT Filed: Dec. 3, 2008
(86) PCT No.: PCT/GB08/51145

§ 371 Date: Feb. 23, 2009

(30) Foreign Application Priority Data
Dec. 4, 2007 (EP) 07270071.9
Dec. 4, 2007 (GB) 0723680.5
Jul. 4, 2008 (EP) 08159775.9

(51) Int. Cl. B06B 1/00; H04R 31/00

(52) U.S. Cl. 367/176; 29/594

(57) ABSTRACT

Improved sonar baffles and backings are disclosed. The sonar baffles and backings include a porous polymer. The baffles and backings can be produced by partial selective sintering of a polyamide powder. Baffles and backings in accordance with exemplary embodiments exhibit advantageous acoustic properties, and can be manufactured to complex geometric specifications without difficulty.

This invention concerns improvements relating to baffles and backings for sonar transducers.

Sonar transducers are used, in marine applications, for detecting the presence of submerged objects, and for locating such submerged objects, by emitting and receiving acoustic energy. Sonar backings and baffles are used, in sonar systems, to shape the sonar beams emitted and received by sonar transducers, and to shield sonar receivers from unwanted noise. As such, sonar baffles and backings must be fabricated from materials that have a high acoustic attenuation, and an acoustic impedance that is significantly different from that of water, the transmission medium for sonar systems used in marine applications. In addition, the materials used for the construction of sonar baffles and backings should be lightweight, able to withstand hydrostatic pressure, and should have acoustic and mechanical properties that are stable with respect to temperature.

Prior to the present invention, acoustic baffles and backings have been fabricated from resin materials filled with high density powders such as alumina, aluminium nitride, or tungsten; or with lightweight fillers such as hollow glass microspheres. Many such materials do not have acoustic properties that are ideal for sonar baffles and backings. Moreover, casting or machining of such materials is necessary in order to obtain the desired geometry of baffle or backing. Particularly where complex geometries are involved, or where only small numbers of baffles or backings are to be made, a more convenient manufacturing method is desirable.

It is an aim of the present invention to provide a sonar baffle or backing fabricated from an alternative material, which alternative material has acoustic properties that make it better suited to application in sonar baffles and backings than prior known materials. It is a further aim to provide an improved method of manufacture of sonar baffles or backings.

In broad terms, the present invention resides in the concept of applying selective laser sintering to the fabrication of sonar baffles and backings. By only partially sintering a polymer powder, using selective laser sintering apparatus, a porous polymer that has the acoustic and mechanical properties desired for sonar baffles and backings can be obtained. Moreover, the use of selective laser sintering allows complex geometries to be rapidly and economically fabricated.

In accordance with a first aspect of the present invention, there is provided a baffle or backing for a sonar transducer comprising a porous partially-sintered powder. Conveniently, the porous partially sintered powder may comprise a porous polymer. The porous polymer may be porous polyamide. The porous partially sintered powder may be configured to have an acoustic impedance substantially different to the acoustic impedance of water. Advantageously, embodiments in accordance with the first aspect of the invention can be rapidly and economically manufactured using existing rapid-prototyping technology, and, using the technique of only partially sintering the polymer, it is possible to tailor the acoustic properties of the baffle to a particular application. The invention extends to sonar apparatus comprising a sonar transducer in combination with a baffle or backing as described above.

In accordance with a second aspect of the present invention, there is provided a method of manufacturing a baffle or backing for a sonar transducer comprising the step of selective laser sintering of a starting material, the step of selective laser sintering comprising using a laser configured to only partially sinter the starting material to result in a porous material. The technique of selective laser sintering allows baffles having complex geometries to be produced rapidly and efficiently, whilst, by only partially sintering the starting material, the degree of porosity of the resulting structure can be tailored to provide the desired acoustic impedance for the baffle. The starting material, in one particular embodiment described in further detail below, is a polymer powder, more particularly a polyamide powder. It is envisaged that in most applications, for example where it is necessary to form electrical connections to the sonar transducer on the baffle or backing, it will be advantageous for the starting material to be electrically non-conducting.

The invention extends to the use of porous polymer for a sonar baffle or backing, and to the use of partially-sintered polymer for a sonar baffle or backing.

The above and further features of the invention are set forth with particularity in the appended claims and will be described hereinafter with reference to various exemplary embodiments and to the accompanying drawings in which:

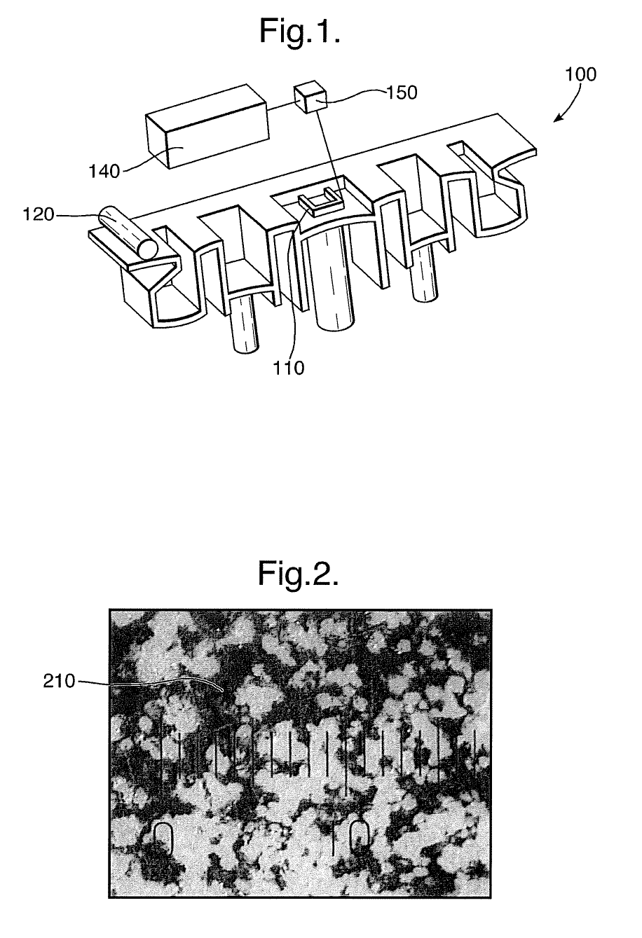

FIG. 1 is a schematic illustration of apparatus for selective laser sintering;

FIG. 2 is a photograph of the microstructure of a porous polymer produced by partial laser sintering;

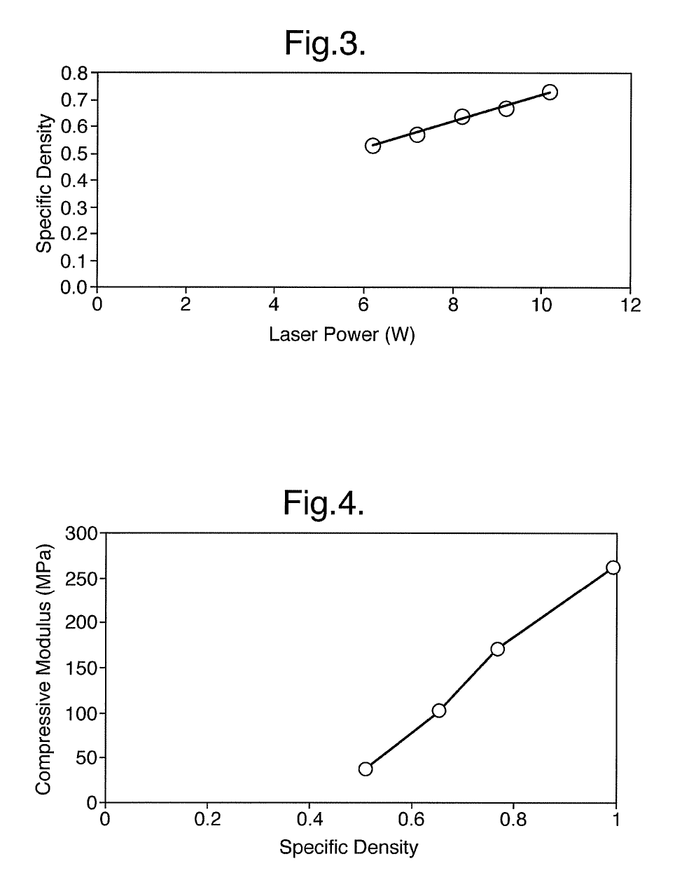

FIG. 3 is a graph illustrating the variation of specific density of the porous polymer of FIG. 2 with the power of the sintering laser;

FIG. 4 is a graph illustrating the variation of compressive modulus with specific density for the porous polymer of FIG. 2; and

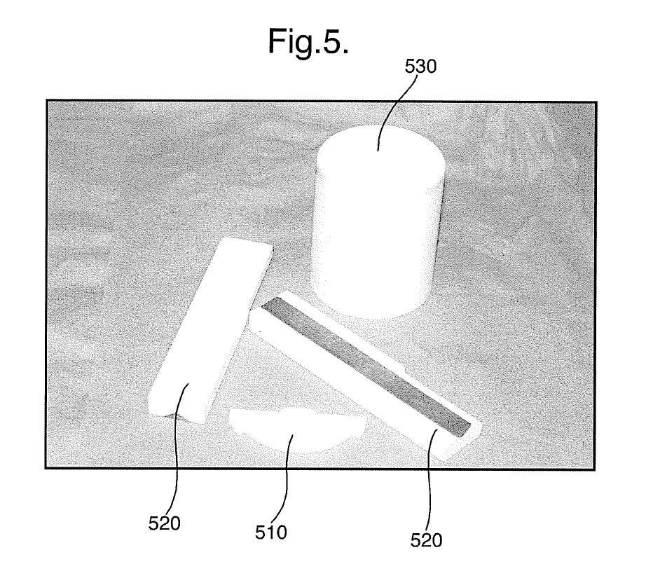

FIG. 5 is a photograph of various acoustic baffles and backings according to embodiments of the present invention.

Sonar baffles and backings in accordance with the embodiments of the invention described below are fabricated using selective laser sintering. Selective laser sintering machines are available from 3D Systems of Rock Hill, S.C. Selective laser sintering technology is disclosed, for example, in International Patent Application, Publication Number WO 88/02677. A schematic illustration of a selective laser sintering machine 100 is shown in FIG. 1, and briefly described in the following. The skilled reader is referred to the above-referenced International patent application for a fuller description of the selective laser sintering technology. A part is manufactured on build platform 110, on which layers of powder are selectively sintered to progressively build the part. A thin layer of powder, nominally 0.1 mm thick, is spread across the build platform 110. Roller 120 is used to ensure that the layer is uniform. A laser beam 130, emitted by laser 140, is scanned across the layer of powder by movement of mirror 150, such that only selected areas of the layer of powder are sintered. This forms a cross-section of the part that is to be built. The build platform is then lowered, and the process repeated to form the next layer of the part. In this way, parts having complex geometries can be built up layer-by-layer. At the end of the process, loose, unsintered powder is removed, normally by suction through a vacuum nozzle.

Powdered starting materials are also available from 3D Systems. One exemplary such starting powder is DuraForm® PA Plastic, a polyamide material that can be sintered using, for example, a carbon dioxide laser. To produce parts using standard laser sintering techniques, a Sinterstation® HiQ, using a CO₂ laser at a power of 13 W is used. Fully-sintered DuraForm® polyamide has a density of 1 g/cm³. By reducing the laser power, the powdered polyamide starting material can be partially sintered, resulting in a porous, lower density material. A photograph of the microstructure of such a partially sintered polyamide material is shown in FIG. 2. This particular partially sintered material was fabricated using a laser power of 10.2 W. Each division on the scale superimposed on the photo represents an actual length of 100 μm. As can be seen, the structure is porous, with a large number of voids (that show up as the darker areas of the photograph). The voids have a typical size of order 200 μm to 300 μm. The particular structure shown is an open-cell foam-like structure. Such structures can absorb adhesives used in attachment of the baffles or backings to other components of the sonar transducer, filling the voids and deleteriously affecting the acoustic properties of the baffle. Therefore, care must be taken when selecting adhesives to ensure that such filling does not take place. Similarly, encapsulation resins must also be carefully selected in order to avoid filling of the voids in the structure. Alternatively, the baffle can be sealed immediately after its fabrication, by application of a spray laquer, to prevent absorption of other materials.

By varying the laser power, the density of the resulting material, the size of the voids, and therefore the acoustic properties of the material, can be varied, and thus tailored to a particular acoustic application. In particular, the material can be used to form a backing material or baffle for a sonar transducer. The particular material illustrated in FIG. 2 has voids of a size that make it well suited to application at high sonar frequencies, in the range between 200 kHz and 2 MHz. FIG. 3 illustrates the variation of the specific density (the density of the partially-sintered part relative to the density of water) of the partially-sintered part with the laser power applied by the selective laser sintering system. As can be seen from the graph, the measured specific density varies from around 0.55 for a laser power of 6 W, to 0.73 for a laser power of 10.2 W. The acoustic impedance varies with the density of the material, and more particularly, can be estimated from the density using the relationship Z=ρc, where Z is the acoustic impedance of the material, ρ is the density of the material, and c is the speed of sound within the material. Taking the speed of sound in the partially sintered powder to be 700 ms⁻¹, as has been measured in the material having a specific density of 0.73, these values result in a variation of acoustic impedance from 0.385 MPa·s·m⁻¹ to 0.511 MPa·s·m⁻¹. These values are significantly different to the characteristic acoustic impedance of water, 1.5 MPa·s·m⁻¹. Thus the partially-sintered powder can be expected to have acoustic properties appropriate to application as backings or baffles for sonar transducers.

However, it is clear that the compressive strength of the material will also vary significantly with the density of the partially-sintered powder. FIG. 4 illustrates the variation of the compressive modulus of the partially-sintered powder with specific density. It can be seen from the graph that the compressive modulus is less than 50 MPa for a specific density of 0.55, rising to 250 MPa for a specific density of 1. For underwater operations at a depth of up to 50 m, material with a compressive modulus of above 33 MPa is suitable. Thus the Duraform® having a specific density of around 0.5 would be suitable for such operations, which include diving and littoral activities. For operations at a depth of 300 m, the material having a specific density of around 0.7 and a compressive modulus of around 150 MPa is suitable. 80% of offshore underwater activities occur at a depth of less than 300 m.

From the above, it can be seen that the acoustic and mechanical properties of partially-sintered Duraform® PA make it advantageous for use in the manufacture of baffles or backings for sonar transducers. Moreover, the use of partial selective laser sintering enables parts of complex geometry to be manufactured rapidly and economically, using the well established techniques of selective laser sintering, but applying a lower laser power. FIG. 5 is a photograph of a number of baffles and backings for sonar systems in accordance with embodiments of the present invention, and manufactured in accordance with embodiments of the invention using partial selective laser sintering. By way of example, backing 510 is a backing for a curved sonar projector adapted for use in the nose of a submersible mine-neutralising vehicle; rectangular baffles 520 are for use in a 48 channel receive array in the same vehicle; and the cylinder 530 of 50 mm diameter is a surround for a calibrated 500 kHz hydrophone.

It is to be noted that the above described embodiments are purely exemplary, and that variations and modifications to these embodiments, that will be obvious to those skilled in the art, are possible without departing from the scope of the invention, which is defined in the accompanying claims. For example, whilst, in the above, it has been described to reduce the applied laser power in order to achieve partial laser sintering of polyamide powder, it will be immediately obvious that a similar effect can be achieved by increasing the scan rate of the laser beam across the surface of the powder in the selective laser sintering machine. Moreover, those skilled in the art will appreciate that sonar backings and baffles can be made from a number of porous polymers, and not only polyamide, whilst still retaining the beneficial acoustic and mechanical properties described above, and the advantages of convenient, rapid, and economical manufacture associated with the selective laser sintering technique.

Finally, it is noted that it is to be clearly understood that any feature described above in relation to any one embodiment may be used alone, or in combination with other features described, and may also be used in combination with one or more features of any other of the embodiments, or any combination of any other of the embodiments.

1-14. (canceled)

15. A baffle for a sonar transducer comprising a porous partially-sintered powder.

16. A baffle as claimed in claim 15 wherein the porous partially sintered powder comprises a porous polymer.

17. A baffle as claimed in claim 15 wherein the porous polymer is porous polyamide.

18. A baffle as claimed in claim 15 wherein the porous partially-sintered powder is configured to have an acoustic impedance substantially different to the acoustic impedance of water.

19. Sonar apparatus comprising a sonar transducer in combination with a baffle as claimed in claim 15.

20. A backing for a sonar transducer comprising a porous partially-sintered powder.

21. A method of manufacturing a baffle for a sonar transducer comprising the step of selective laser sintering of a starting material, the step of selective laser sintering comprising using a laser configured to only partially sinter the starting material to result in a porous material.

22. A method as claimed in claim 21 wherein the starting material comprises a polymer powder.

23. A method as claimed in claim 21 wherein the starting material is a polyamide powder.

24. A method as claimed in claim 21 wherein the starting material is electrically non-conducting.

25. A method of manufacturing a backing for a sonar transducer comprising the step of selective laser sintering of a starting material, the step of selective laser sintering comprising using a laser configured to only partially sinter the starting material to result in a porous material.

26. Use of porous polymer for a sonar baffle.

27. Use of partially-sintered polymer for a sonar baffle.

28. Uses as claimed in claim 26 wherein the polymer is polyamide.
